(19) United States
(12) Patent Application Publication
(10) Pub. No.: US 2026/0134529 A1
(43) Pub. Date: May 14, 2026

(54) CAMERA MONITOR SYSTEMS AND METHODS FOR PRE-TRIP INSPECTION

(71) Applicant: Stoneridge Electronics AB, Solna (SE)

(72) Inventors: Banuprakash Murthy, Novi, MI (US); Liang Ma, Rochester, MI (US)

(21) Appl. No.: 18/945,843

(22) Filed: Nov. 13, 2024

(51) Int. Cl. G06T 7/00; B60R 1/26; G06V 10/25; G06V 10/764; G06V 20/56; H04N 7/18

(52) U.S. Cl. CPC G06T 7/0002; B60R 1/26; G06V 10/25; G06V 10/764; G06V 20/56; H04N 7/183; G06T 2207/30252

(57) ABSTRACT

A method includes capturing at least one model image including a conduit between a tractor and a trailer, storing the model image, and classifying the model image as showing one of a connected position or an unconnected position of the conduit. The method includes capturing a second image including the conduit between a tractor and a trailer, comparing the second image to the model image, determining whether the conduit in the second image is in the connected position or the unconnected position based on the comparing, and notifying an operator whether the conduit is in the connected position or the unconnected position based on the determining.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras disposed about the vehicle to provide an enhanced field of view to a vehicle operator on one or more displays located in the vehicle cabin. In some examples, mirror replacement systems within the CMS can cover a larger field of view than a conventional mirror, or can include views that are not fully obtainable via a conventional mirror.

### SUMMARY

A method according to one or more examples in this disclosure includes capturing at least one model image including a conduit between a tractor and a trailer; storing the at least one model image; classifying the at least one model image as showing one of a connected position or an unconnected position of the conduit; capturing a second image including the conduit between a tractor and a trailer; comparing the second image to the at least one model image; determining whether the conduit in the second image is in the connected position or the unconnected position based on the comparing step; and notifying an operator whether the conduit is in the connected position or the unconnected position based on the determining step.

In a further example of the disclosed examples, the capturing at least one model image step includes capturing a plurality of model images including the conduit between the tractor and the trailer.

In a further example of the disclosed examples, the conduit includes electrical wiring.

In a further example of the disclosed examples, the conduit includes a fluid hose.

In a further example of the disclosed examples, the notifying occurs during a pre-trip inspection phase.

In a further example of the disclosed examples, the method includes preprocessing the second image to match a format of the at least one model image.

In a further example of the disclosed examples, the method includes displaying the second image on a display in the tractor.

In a further example of the disclosed examples, the capturing at least one model image step includes capturing a plurality of model images including the conduit between the tractor and the trailer in the connected position and capturing a plurality of model images including the conduit between the tractor and the trailer in the unconnected position, the method including: determining that one of the plurality of model images was taken under conditions most similar to conditions in which the second image was captured.

In a further example of the disclosed examples, the method includes generating a confidence score as to whether the conduit is in the connected position based on the comparing; and at least one of (i) notifying the operator that the conduit is in the connected position if the confidence score is above a threshold value, and (ii) notifying the operator that the conduit is in the unconnected position if the confidence score is below the threshold value.

In a further example of the disclosed examples, the conduit includes a J560 connector.

In a further example of the disclosed examples, the method includes capturing at least one trailer axle model image including a rear axle of the trailer; storing the at least one trailer axle model image; classifying the at least one trailer axle model image as showing one of a proper trailer position or an improper trailer lean position; capturing a fourth image including the rear axle; comparing the fourth image to the at least one trailer axle model image; determining whether the trailer in the second image is in the proper trailer position or the improper trailer lean position based on the comparing of the fourth image; and notifying an operator whether the trailer is in the proper trailer position or the improper trailer lean position based on the determining step for the fourth image.

A camera monitor system (CMS) according to one or more examples from this disclosure includes a camera mounted to a tractor and positioned to capture a field of view including conduit between the tractor and a trailer; and processing circuitry operatively connected to memory and configured to: store at least one model image of the field of view with the conduit in a connected position or an unconnected position; receive a captured second image from the camera; and determine whether the conduit is in the connected position or the unconnected position based on comparison of the second image to the at least one model image.

In a further example of the disclosed examples, the camera is rearward facing.

In a further example of the disclosed examples, the field of view includes a kingpin.

In a further example of the disclosed examples, the system includes a display for displaying the second image.

In a further example of the disclosed examples, the system includes a display for displaying a status indicative of the connected position or the unconnected position in the second image.

In a further example of the disclosed examples, the conduit includes a J560 connector.

In a further example of the disclosed examples, the processing circuitry is configured to: store a plurality of model images of the field of view with the conduit in the connected position or the unconnected position; determine that one of the plurality of model images has conditions most similar to conditions of the captured second image; and compare the captured second image to the one of the plurality of model images.

In a further example of the disclosed examples, the processing circuitry is configured to: notify an operator whether the conduit is in the connected position or the unconnected position based on the determining.

In a further example of the disclosed examples, the system includes a camera positioned to capture a field of view including a rear axle of the trailer; wherein the processing circuitry is configured to: store at least one trailer axle model image of the field of view with the trailer in a proper position or an improper leaned position; receive a captured image from the camera; and determine whether the trailer in the proper position or the improper leaned position based on comparison of the image to the at least one trailer axle model image.

These and other features may be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least narrow and wide fields of view alongside the vehicle (e.g., Class II and Class IV views).

FIG. 2 is a schematic birds-eye view of the commercial truck of FIG. 1 with a CMS providing, for example, Class II, Class IV, Class V, Class VI, and Class VIII views.

FIG. 3 is a schematic top view of an example vehicle cabin interior.

FIG. 4 is a perspective view of an example vehicle cabin interior.

FIG. 5 illustrates an example camera on an example tractor.

FIG. 6 illustrates a view of another example camera.

FIG. 7 schematically illustrates an example connection configuration for an example CMS.

FIG. 8A illustrates an example image taken of conduit in a connected position.

FIG. 8B illustrates an example image taken of conduit in an unconnected position.

FIG. 9 is a flowchart of an example method in accordance with this disclosure.

### DETAILED DESCRIPTION

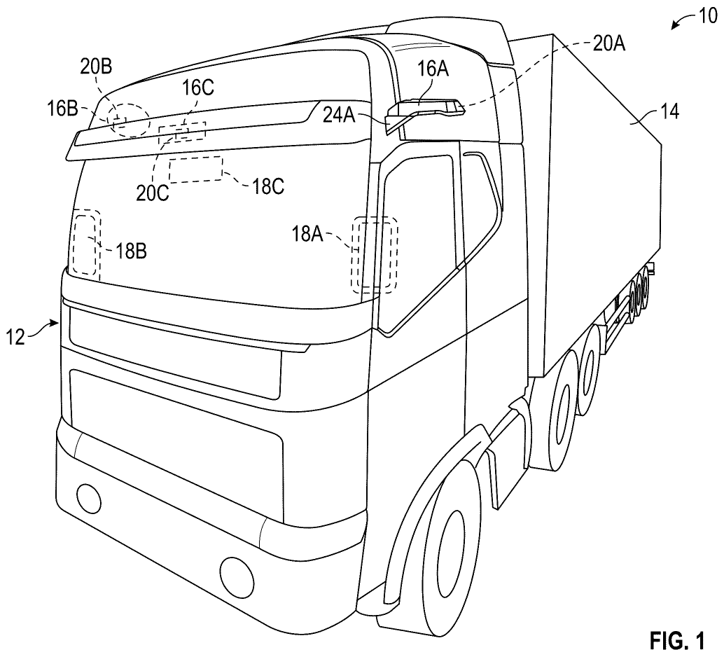

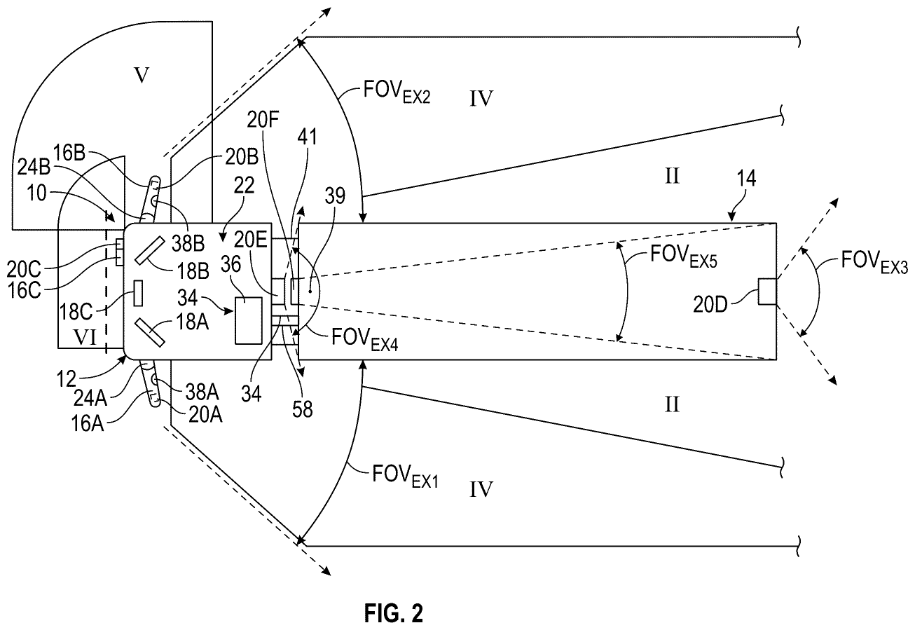

A schematic view of a commercial vehicle 10 is illustrated in FIGS. 1-2. The vehicle 10 includes a vehicle cab or “tractor” 12 for pulling a trailer 14. Although the vehicle 10 is depicted as a commercial truck in this disclosure, it is understood that other types of vehicles may be used, and it should be understood that other configurations may be utilized for the vehicle cab 12 and/or trailer 14 (e.g., different types or quantities of trailers).

Referring now to FIGS. 1 and 2, camera arms 16A-B each include a respective base 24A-B that is secured to, for example, the tractor 12. The pivoting camera arms 16A-B are supported by the respective bases 24A-B and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (see FIG. 2), which are legally prescribed views in the commercial trucking industry. Although rotatable camera arms 16 are depicted, it is understood that this is a non-limiting example and that non-rotatable camera arms may be used.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but is intended as an example of the type of view provided to a display from a particular camera.

Each camera arm 16A-16B may also provide a housing that encloses electronics, e.g., a controller, that are configured to provide various features of the CMS 15. The camera arms 16A-B may be mounted either at a roof-mount location over the cab door (as shown in FIG. 1), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2).

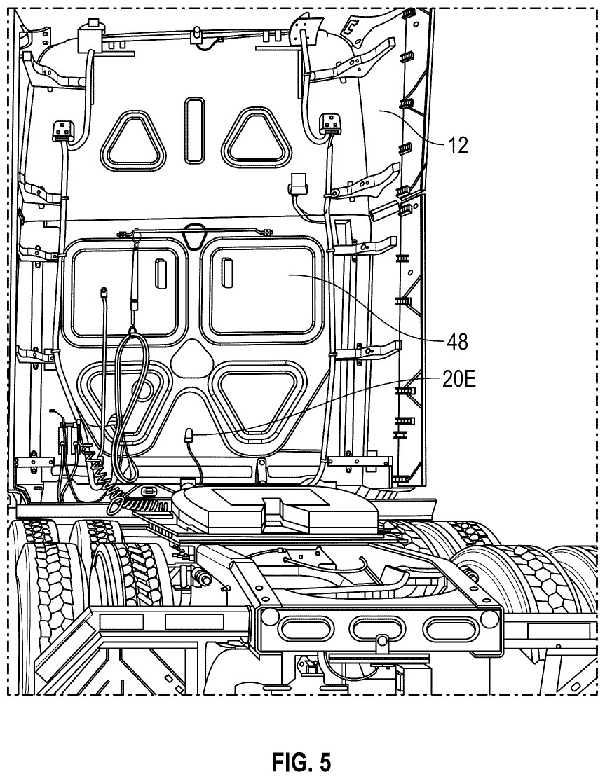

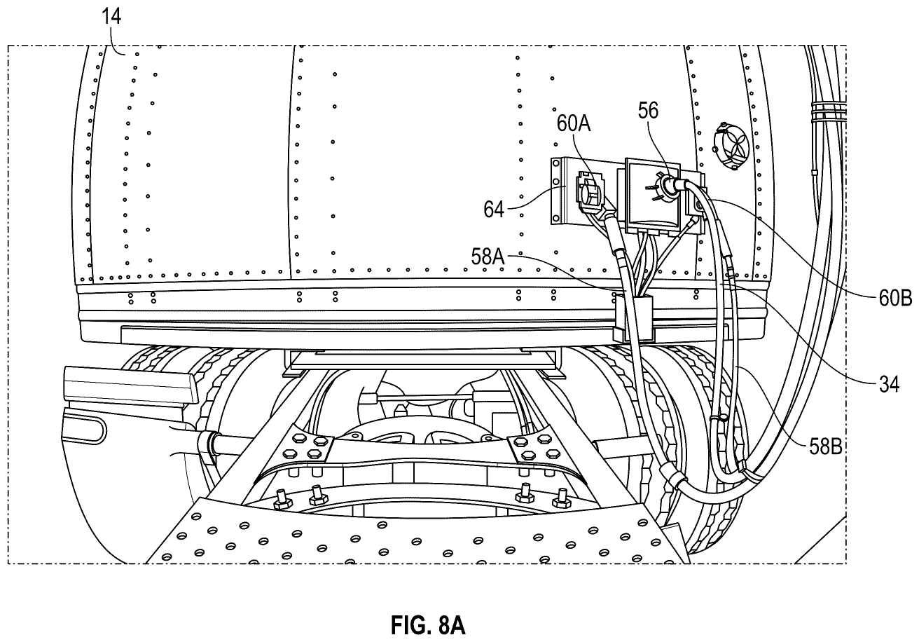

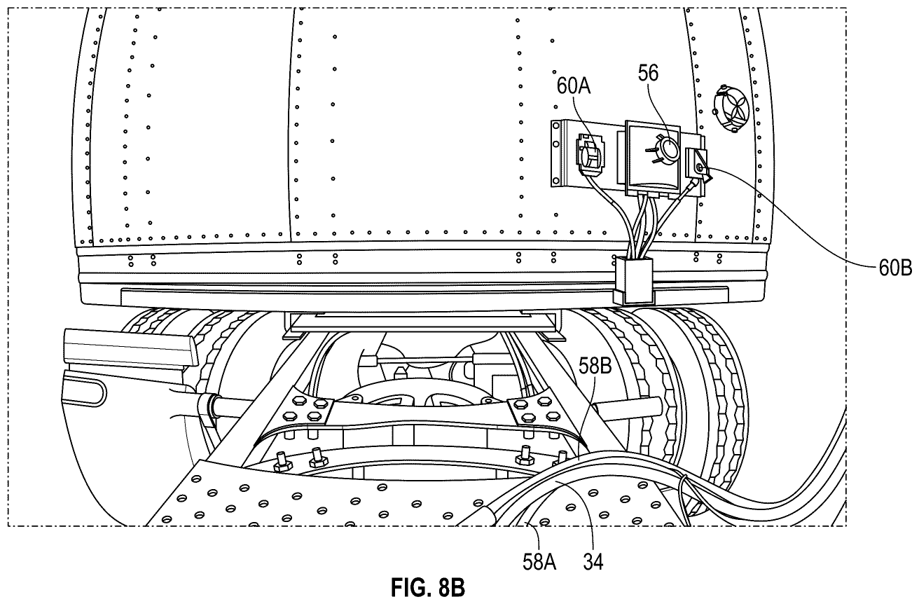

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The FOV_{EX4} may include one or more conduits that providing various connections (e. g, fluid, electrical) between the tractor 12 and trailer 14. The FOV_{EX4} may include electrical wiring 34 that provides electrical connection between the tractor 12 and trailer 14. The FOV_{EX4} may include fluid hoses 58 (e.g., air hoses for braking) that provides fluid connection between the tractor 12 and trailer 14. The FOV_{EX4} may include a view of the kingpin 39. The fifth wheel camera 20E may be mounted anywhere between the lateral plane of the fifth wheel fixture and the top/roof edge of the tractor, for example. FIG. 5 illustrates an example location for the fifth wheel camera 20E on a rear face 48 of the tractor 12. FIGS. 8A and 8B show example images taken with the camera 20E.

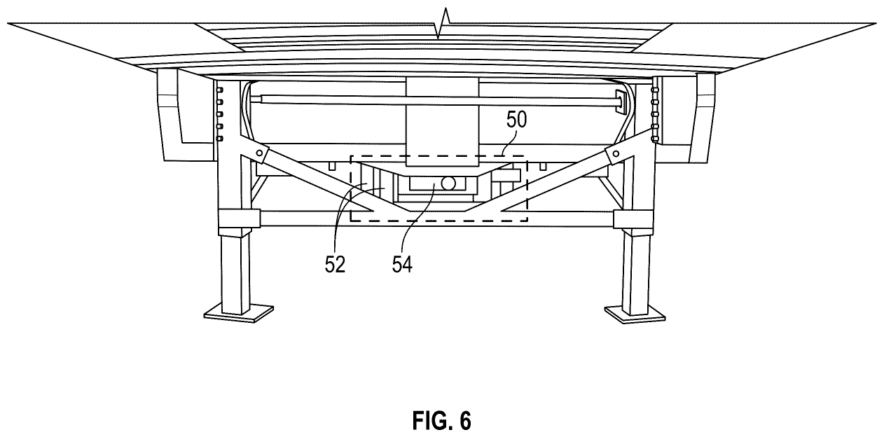

Referring back to FIG. 2, a camera 20F may be mounted to the trailer frame 41 or otherwise positioned to provide a field of view FOV_{EX5} underneath the trailer 14 and looking rearward. FIG. 6 illustrates an example FOV_{EX5} including a region 50 of the rear axle 52 and rear wheels 54. As discussed herein, the camera 20F may assist in detecting lean or wheel alignment issues, such as due to improper tire pressures. The camera 20F may be mounted below the fifth wheel of the tractor 12. While one example mounting position for the camera 20F is shown, others may be utilized. For example, the camera 20F could be mounted to a portion of the trailer 14 and capture the field of view shown in FIG. 6.

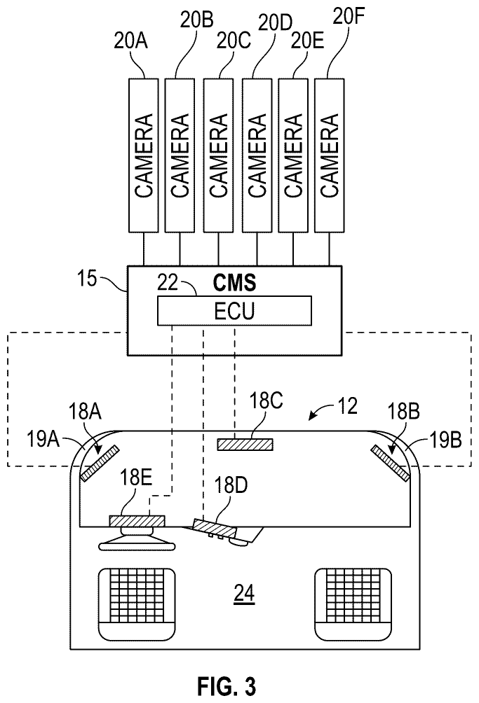

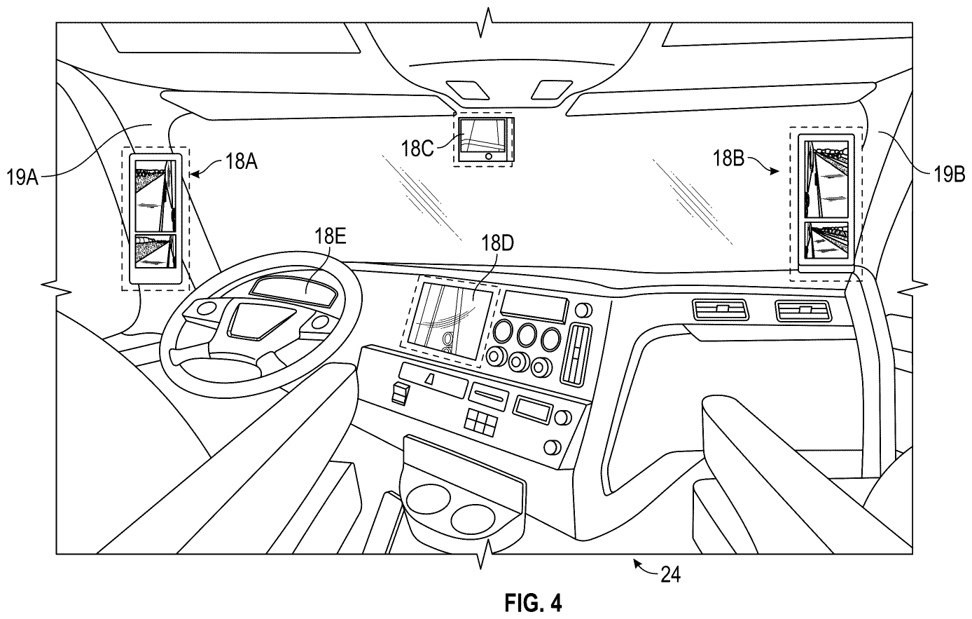

FIG. 3 is a schematic top view of an example vehicle cabin interior 26, and FIG. 4 is a perspective view of the vehicle cabin interior 26. Referring now to FIGS. 3-4 with continued reference to the preceding figures, electronic displays 18A-E (e.g., which may be video displays, such as LCD displays) and cameras 20A-E are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to display image feeds from those cameras.

The CMS 15 includes a CMS electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The ECU 22 is configured to be compatible with a variety of different cameras, including, e.g., cameras with different resolutions (e.g., 3-8 megapixels), cameras that utilize different communication standards, and cameras that include or omit IR illumination.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 26 near the top center of the windshield and may be used to display the Class V and Class VI views, which are toward the front of the commercial vehicle 10, or a backup camera view (from camera 20D or 20E) to the driver. Display 18D is provided in a center console area of the vehicle cabin interior 26, and may be used for other purposes, such as navigation, infotainment, etc. Display 18E may be part of an instrument cluster, for example. The displays 18A-E face a driver region within the vehicle cabin interior 26 where an operator is seated on a driver seat.

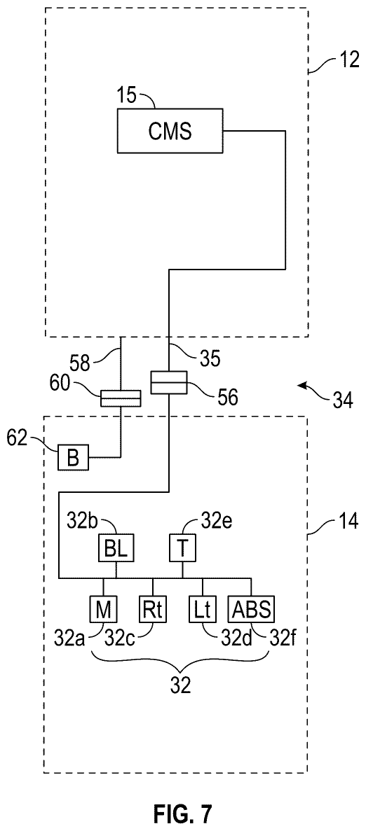

Referring to FIG. 7, an example connection configuration is shown schematically. The trailer 14 may include trailer components 32, such as a marker light 32a, a brake light 32b, a turn signal (right, 32c; left, 32d), a tail light 32 e, and an anti-lock braking system component 32f. Each of the trailer components 32a-32f (collectively, trailer components 32) are responsive to a control signal from one or more vehicle controls. The trailer components 32 on the trailer 14 are connected to the tractor 12 by a typical wiring harness 34. As an example, a standard 7-pin jumper cable 35 interconnects the tractor 12 and trailer 14 at one or more connectors 56, which are of a typical configuration. The disclosure is not limited to any particular pin arrangement. For example, the pin arrangement of SAE J560 and ISO1185 could be used.

The brakes 62 may be connected to the tractor 12 by one or more air hoses 58 connected at one or more connectors 60. In implementations, the connector 60 may be a gladhand connector. Air may be used to create force to apply the brakes 62 in the trailer 14, with the air being communicated from the tractor 12 to the trailer 14 through one or more hoses 58 and connectors 60.

The CMS 15 may be utilized to determine whether various vehicle features are in the proper position. As one illustrative example, the CMS 15 may be utilized to determine whether one or more conduits between the tractor 12 and the trailer 14, such as the example harness 34, fluid hose 58, or combinations thereof, are in a connected position or an unconnected position. In some implementations, a determination of whether the conduit is in a connected position or an unconnected position is performed during a vehicle pre-trip inspection, a detailed check performed before operating the vehicle to ensure that it is in safe and proper working condition. Other phases of vehicle operation would benefit from this disclosure.

The CMS 15 may capture and store one or more model images of conduit, such as images of the harness 34 and fluid hose 58 from the camera 20E. The model images may include one or more images of the conduit in a connected position where the conduit between the tractor 12 and the trailer 14 is connected.

FIG. 8A illustrates an example image captured by the camera 20E of the conduits 34, 58A, 58B in the connected position, which may be utilized as a model image. The harness 34 is connected at its connector 56, and the fluid hoses 58A, 58B are connected at their respective connectors 60A, 60B. As shown, the connectors 56, 60A, 60B are located on the junction box 64 of the trailer 14, which is in the field of view of camera 20E. In implementations, the air hose 58A may provide the service line, and the air hose 58B may provide the emergency line. Other conduit configurations would benefit from this disclosure.

The model images may include one or more images of one or more of the conduits in an unconnected position where one or more of the conduits between the tractor 12 and the trailer 14 is not connected. FIG. 8B illustrates an example image captured by the camera 20E of the conduits 34, 58A, 58B in the unconnected position, which may be utilized as a model image. The harness 34 is not connected at its connector 56, and the fluid hoses 58A, 58B are not connected at their respective connectors 60A, 60B.

The model images may be classified as showing the connected position or the unconnected position for each respective conduit. The model images may include variations in lighting, angles, types of connectors, types of conduit, and conduit configurations. A model image may include one or more conduits in a connected position and one or more conduits in an unconnected position.

In implementations, the classified model images may be utilized as a dataset to train a deep neural network model to classify whether a captured image shows a conduit in a connected position or an unconnected position, which may be deployed to the ECU 22.

The CMS 15 may capture a current image of the conduit and compare the captured image to one or more model images. The image may be captured with the camera 20E. In some implementations, the CMS 15 may crop the model image(s) to create a region of interest (ROI) including the conduit areas. In some implementations, the CMS 15 may compare the model image's features to the new captured image's ROI. In some implementations, the CMS 15 may preprocess (e.g., crop, resize, normalization) the captured image to match a format of the at least one model image. In implementations, the captured image may be displayed within one of the aforementioned displays 18.

The CMS 15 may determine whether the conduit in the captured image is in the connected position or the unconnected position based on the comparison. The determination may include assigning a confidence level or score to the captured image indicative of the one or more conduits being connected.

Based on the determination, the CMS 15 may notify an operator whether the conduit is in the connected position or the unconnected position. In implementations, the CMS 15 may generate a confidence score as to whether the conduit is in the connected position based on the comparing. The CMS 15 may then notify the operator that the conduit is in the connected position if the confidence score is above a threshold value, and/or notifying the operator that the conduit is in the unconnected position if the confidence score is below the threshold value. Additionally or alternatively, the CMS 15 may then notify the operator of the confidence score.

Additionally or alternatively, the CMS 15 may determine whether the trailer 14 has a lean, which may be the result of improper tire pressures, an unbalanced load in the trailer, a road bank at curve entry/exit, etc., as some examples. In implementations, the CMS 15 may make this determination as part of a pre-trip inspection process. The systems and methods for trailer lean determination may be similar to those described above regarding conduit connection determination. These systems and methods may also be utilized for checking wheel spacing (e.g., the spacing between adjacent trailer wheels or trailer wheels and other components).

Referring to FIGS. 2 and 6, the CMS 15 may capture and store one or more model images of the region 50. The model images may include one or more images classified as having the rear axle 52 in the proper position. The model images may include one or more images classified as having the rear axle 52 in the improper leaned position. The model images may include variations in lighting and angles. The model images may be captured by the camera 20F.

In implementations, the classified model images may be utilized as a dataset to train a deep neural network model to classify whether a captured image shows a trailer in a proper position, which may be deployed to the ECU 22. In implementations, a DNN model can be trained whether features are in the appropriate position by gathering a dataset with labeled examples of the features in one or more positions, and using a neural network model to learn patterns in the data that distinguish the feature from the rest of the image.

One or more additional images may be captured by the camera 20F. the CMS 15 may compare the one or more captured images to the model images. Based on the comparison, the CMS may determine whether the trailer is in a proper position. Based on the comparison, the CMS may determine whether the trailer is in an improper leaned position.

Based on the determination, the CMS 15 may notify an operator whether the trailer is in a proper position or an improper leaned position. In implementations, the CMS 15 may generate a confidence score as to whether the trailer is in the proper position based on the comparing. The CMS 15 may then notify the operator that the conduit is in the connected position if the confidence score is above a threshold value, and/or notifying the operator that the conduit is in the unconnected position if the confidence score is below the threshold value. Additionally or alternatively, the CMS 15 may then notify the operator of the confidence score. The notifications described herein may be indicated on a display 18 of the vehicle 10.

Similar systems and methods may utilize the view of the camera 20F to check wheel spacing, such as by comparing one or more captured images to one or more model images having proper or improper spacing.

The CMS 15 may thus provide one or more of tire pressure monitoring, wheel spacer check, and conduit connection check based on image processing. Although illustrative examples are disclosed, the systems and methods disclosed herein may be utilized for other vehicle features. The systems and methods disclosed herein may be utilized for other vehicle features that would otherwise be checked manually during pre-trip inspection processes of the prior art. The systems and methods disclosed herein may be utilized to supplement, or as substitutes for, other inspection methods.

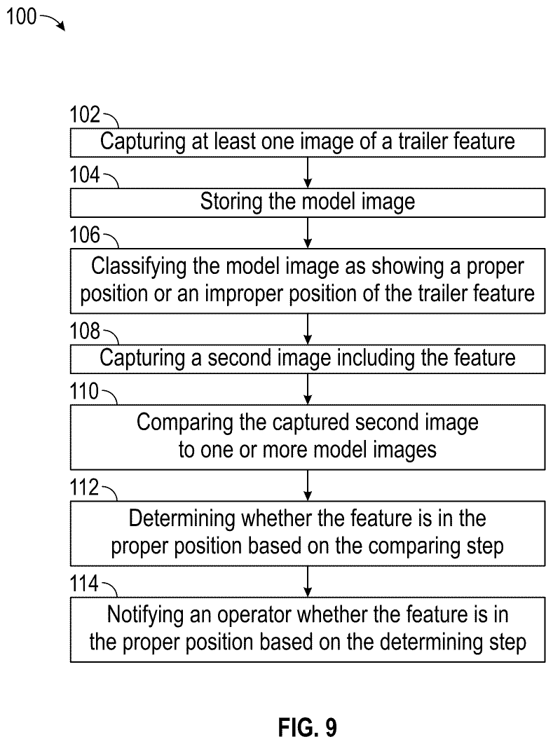

FIG. 9 illustrates a flowchart of an example pre-trip inspection method 100. Fewer or additional steps than are recited below could be performed within the scope of this disclosure, and the recited order of steps is not intended to limit this disclosure. At 102, the method 100 may include capturing at least one image of a trailer feature. At 104, the method 100 may include storing the model image.

At 106, the method 100 may include classifying the model image as showing a proper position or an improper position of the trailer feature. As one example, the step 106 may include classifying the image as showing a conduit in a connected position or an unconnected position. As another example, the step 106 may include classifying an image as showing a proper trailer position or an improper leaned trailer position.

At 108, the method 100 may include capturing a second image including the feature. Step 108 may occur after one or more of steps 102-106 in implementations. The image may be captured with camera one or more of 20E and 20F in implementations.

At 110, the method 100 may include comparing the captured second image to one or more model images. Step 110 may occur after step 108 in implementations.

At 112, the method 100 may include determining whether the feature is in the proper position based on the comparing step 110. Step 112, may occur after step 110 in implementations.

At 114, the method may include notifying an operator whether the feature is in the proper position based on the determining step 112. Step 114, may occur after step 114 in implementations.

An example method in accordance with this disclosure may be said to include capturing at least one model image including a conduit between a tractor and a trailer, storing the at least one model image, classifying the at least one model image as showing one of a connected position or an unconnected position of the conduit, capturing a second image including the conduit between a tractor and a trailer, comparing the second image to the at least one model image, determining whether the conduit in the second image is in the connected position or the unconnected position based on the comparing step, and notifying an operator whether the conduit is in the connected position or the unconnected position based on the determining step. Fewer or additional steps than are recited above could be performed within the scope of this disclosure, and the recited order of steps is not intended to limit this disclosure.

An example method in accordance with this disclosure may be said to include capturing at least one trailer axle model image including a rear axle of the trailer, storing the at least one trailer axle model image, classifying the at least one trailer axle model image as showing one of a proper trailer position or an improper trailer lean position, capturing an image including the rear axle; comparing the image to the at least one trailer axle model image, determining whether the trailer in the second image is in the proper trailer position or the improper trailer lean position based on the comparing, and notifying an operator whether the trailer is in the proper trailer position or the improper trailer lean position based on the determining step. Fewer or additional steps than are recited above could be performed within the scope of this disclosure, and the recited order of steps is not intended to limit this disclosure.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A method, comprising:
capturing at least one reference image including a conduit between a tractor and a trailer, the conduit including at least one of electrical wiring and a fluid hose;
storing the at least one reference image;
classifying the at least one reference image as showing one of a connected position or an unconnected position of the conduit;
capturing a second image including the conduit between a tractor and a trailer;
extracting one or more visual features from the second image and comparing the extracted visual features to corresponding visual features associated with the at least one reference image;
determining whether the conduit in the second image is in the connected position or the unconnected position based on the comparing step; and
notifying an operator whether the conduit is in the connected position or the unconnected position based on the determining step.

2. The method of claim 1, wherein the capturing at least one reference image step includes capturing a plurality of reference images including the conduit between the tractor and the trailer.

3. (canceled)

4. (canceled)

5. The method of claim 1, wherein the notifying occurs during a pre-trip inspection phase.

6. The method of claim 1, comprising:
preprocessing the second image to correspond to the at least one reference image. including at least one of cropping resizing or normalization.

7. The method of claim 1, comprising:
displaying the second image on a display in the tractor.

8. The method of claim 1, wherein the capturing at least one reference image step includes capturing a plurality of reference images including the conduit between the tractor and the trailer in the connected position and capturing a plurality of reference images including the conduit between the tractor and the trailer in the unconnected position, the method comprising:
determining that one of the plurality of reference images was taken under conditions most similar to conditions in which the second image was captured.

9. The method of claim 1, comprising:
generating a confidence score as to whether the conduit is in the connected position based on the comparing; and
at least one of (i) notifying the operator that the conduit is in the connected position if the confidence score is above a threshold value, and (ii) notifying the operator that the conduit is in the unconnected position if the confidence score is below the threshold value.

10. The method of claim 1, wherein the conduit includes a J560 connector.

11. The method of claim 1, comprising:
capturing at least one trailer axle reference image including a rear axle of the trailer;
storing the at least one trailer axle reference image;
classifying the at least one trailer axle reference image as showing one of a proper trailer position or an improper trailer lean position;
capturing a fourth image including the rear axle;
extracting one or more visual features from the fourth image and comparing the extracted visual features to corresponding visual features associated with the at least one trailer axle reference image;
determining whether the trailer in the fourth image is in the proper trailer position or the improper trailer lean position based on the comparing; and
notifying an operator whether the trailer is in the proper trailer position or the improper trailer lean position based on the determining step.

12. A camera monitor system (CMS), comprising:
a camera mounted to a tractor and positioned to capture a field of view including conduit between the tractor and a trailer, the conduit including at least one of electrical wiring and a fluid hose; and
processing circuitry operatively connected to memory and configured to:
store at least one model-reference image of the field of view with the conduit in a connected position or an unconnected position;
receive a captured second image from the camera;
extract one or more visual features from the captured second image and compare the extracted visual features to corresponding visual features associated with the at least one reference image; and
determine whether the conduit is in the connected position or the unconnected position based on the comparison of the second image to the at least one reference image.

13. The system of claim 12, wherein the camera is rearward facing.

14. The system of claim 12, wherein the field of view includes a kingpin.

15. The system of claim 12, comprising:
a display for displaying the second image.

16. The system of claim 12, comprising:
a display for displaying a status indicative of the connected position or the unconnected position in the second image.

17. The system of claim 12, wherein the conduit includes a J560 connector.

18. The system of claim 12, wherein the processing circuitry is configured to:
store a plurality of reference images of the field of view with the conduit in the connected position or the unconnected position;
determine that one of the plurality of reference images has conditions most similar to conditions of the captured second image; and
compare the captured second image to the one of the plurality of reference images.

19. The system of claim 12, wherein the processing circuitry is configured to:
notify an operator whether the conduit is in the connected position or the unconnected position based on the determining.

20. The system of claim 12, comprising:
a second camera positioned to capture a second field of view including a rear axle of the trailer; wherein the processing circuitry is configured to:
store at least one trailer axle reference image of the second field of view with the trailer in a proper position or an improper leaned position;
receive a captured fourth image from the second camera;
extract one or more visual features from the captured fourth image and compare the extracted visual features to corresponding visual features associated with the at least one trailer axle reference image: and
determine whether the trailer is in the proper position or the improper leaned position based on comparison of the fourth image to the at least one trailer axle model reference image.

21. A method, comprising:
capturing at least one reference image including a rear axle of a trailer;
storing the at least one reference image;
classifying the at least one reference image as showing one of a proper trailer position or an improper trailer lean position;
capturing a second image including the rear axle of the trailer;
extracting one or more visual features from the second image and comparing the extracted visual features to corresponding visual features associated with the at least one reference image;
determining whether the trailer in the second image is in the proper trailer position or the improper trailer lean position based on the comparing; and
notifying an operator whether the trailer is in the proper trailer position or the improper trailer lean position based on the determining.

22. The method of claim 21, comprising:
generating a confidence score as to whether the trailer is in the proper trailer position based on the comparing; and
at least one of (i) notifying the operator that the trailer is in the proper trailer position if the confidence score is above a threshold value, and (ii) notifying the operator that the trailer is in the improper trailer lean position if the confidence score is below the threshold value.
